(19) United States
(12) Patent Application Publication
(10) Pub. No.: US 2008/0243591 A1
(43) Pub. Date: Oct. 2, 2008

(54) INFORMATION PROCESSING DEVICE, INFORMATION PROCESSING METHOD AND INFORMATION PROCESSING PROGRAM

(75) Inventors: Takeshi Kumazawa, Kawasaki (JP); Yasuo Sugahara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/034,045

(22) Filed: Feb. 20, 2008

(30) Foreign Application Priority Data
Mar. 28, 2007 (JP) JP2007-085189

(51) Int. Cl. G06Q 10/00

(52) U.S. Cl. 705/10; 705/1

(57) ABSTRACT

Included are a customer information storage unit 14 stored with accumulated point count data, a commercial information storage unit 15 stored with commercial article data and price data, an extracting condition storage unit 16 stored with extracting condition data, a date acquiring unit 9 acquiring date data, a price zone searching unit 10 searching for commercial article price zone data matching with the accumulated point count data if the date data and an invalidation date of benefit points come to a predetermined relationship, a recommended commercial article searching unit 11 searching for the commercial article data matching with the price zone of the commercial article, a commercial article announcement generating unit 12 generating an announcement of the commercial article, which describes contents of the retrieved commercial article data, and a commercial article announcement providing unit 13 providing the announcement of the commercial article to the customers.

This application claims the benefit of Japanese Patent Application No. JP2007-085189 filed on Mar. 28, 2007 in the Japanese Patent Office, the disclosure of which is herein incorporated in its entirety by reference.

### BACKGROUND OF THE INVENTION

An information processing device, an information processing method and an information processing program are illustrated.

Nowadays, a variety of online electronic commerce is carried out on the Internet. Further, various types of benefit services such as giving points are provided incidental to the online E-commerce in order to stimulate purchasing appetites of customers.

For example, Patent document 1 discloses a technology of executing a process of matching must-distribute information with a profile, an access history (access log), an event participation history (participation log), etc of the customer, and distributing the electronic mail having a content coincident with a field about which the customer has concern. Moreover, Patent document 2 discloses a technology of easily retrieving a commercial article related to the past-purchased commercial articles from customer's purchase history information accumulated by retailers. Furthermore, Patent document 3 discloses a technology of calculating a deficient point count needed for acquiring a prize ranked higher by one than others, and extracting and introducing the commercial article capable of supplementing the deficient points to the customer.

[Patent document 1] Japanese Patent Laid-Open Publication No. 2001-175761

[Patent document 2] Japanese Patent Laid-Open Publication No. 2002-373275

[Patent document 3] Japanese Patent Laid-Open Publication No. 2002-99801

### SUMMARY OF THE INVENTION

Generally, the customer considers that he or she wants to effectually use the benefit points before validity of the benefit points possessed by the customer himself or herself expires. Hence, it can be said that a timing when the validity of the possessed benefit points is on the verge of its expiration is a timing when the customer requires most the information on the commercial article.

According to the prior arts, the information on the commercial article is distributed irrespective of the timing when the customer wants the information on the commercial article, and hence a sales promotion effect of the distributed information does not work effectually.

Such being the case, it is an object of the present disclosure to provide an information processing device, an information processing method and an information processing program that are capable of enhancing the sales promotion effect by effectually an announcement of the commercial article to the customer.

The present disclosure provides, for solving the problems given above, the customer with the announcement of the commercial article corresponding to accumulated points before the validity of the benefit points given to the customer expires.

To be specific, an information processing device comprises: a customer information storage unit stored with point count data defined as benefit points given to a customer; a commercial article information storage unit stored with commercial article data showing contents of a commercial article and with price data showing a price of the commercial article; an extracting condition storage unit stored with extracting condition data showing an associated relationship between the point count data and price zone data of the commercial article introduced to the customer; a date acquiring unit acquiring date data defined as a present date; a price zone searching unit searching for, when the date data acquired by the date acquiring unit and an invalidation date of the benefit points specified by the point count data stored in the customer information storage unit come to a predetermined relationship, the price zone data of the commercial article, which is associated with the point count data stored in the customer information storage unit by use of the extracting condition data stored in the extracting condition storage unit; a recommended commercial article searching unit searching for the commercial article data matching with a price zone of the commercial article, which is searched for by the price zone acquiring unit, in a way that searches for the price data stored in the commercial article information storage unit; a commercial article announcement generating unit generating an announcement of the commercial article, which describes the contents of the commercial article data searched for by the recommended commercial article searching unit; and a commercial article announcement providing unit providing the announcement of the commercial article, which is generated by the commercial article announcement generating unit, to the customer.

The customer information storage unit is stored with, as data, the accumulated point count of the benefit points given to the customer The accumulated points are obtained by integrating the benefit points given when the customer purchased the commercial articles on Websites.

The commercial article information storage unit is stored with the commercial article data showing contents of the commercial article such as a name, performance and a photo of an external appearance of the commercial article and with the price data showing a price of the commercial article. Further, the extracting condition storage unit is stored with the extracting condition data. The extracting condition data contains the price zone of the commercial article, which should be introduced to the customer, corresponding to the accumulated point count.

It is to be noted that the customer information storage unit, the commercial information storage unit and the extracting condition storage unit may be realized by storage mediums independent of each other and may also be realized by one single storage medium.

The price zone searching unit, when the date data and the invalidation date of the benefit points specified by the point count data come to the predetermined relationship, searches for the price zone data of the commercial article introduced to the customer, corresponding to the accumulated point count of the customer in a way that searches for the extracting condition data.

When the price zone searching unit searches for the price zone data, the recommended commercial article searching unit searches for the commercial article data that satisfies the price zone data.

When the recommended commercial article searching unit searches for the commercial article data of the commercial article introduced to the customer, the commercial article announcement generating unit generates the announcement of the commercial article, which describes the contents of the commercial article data. The announcement of the commercial article may take a format of a Web page displayed when the customer logs in the website and may also take a format of an electronic mail that is sent directly to the customer.

When the commercial article announcement generating unit generates the announcement of the commercial article, the commercial article announcement providing unit provides the customer with the announcement of the commercial article. If the announcement of the commercial article generated by the commercial article announcement generating unit takes the Web page format, the commercial article announcement providing unit makes the Web page accessible from the communication network such as the Internet. Further, if the announcement of the commercial article generated by the commercial article announcement generating unit takes the E-mail format, the commercial article announcement providing unit sends the E-mail to the customer.

From what has been described above, the information processing device according to the present disclosure gets capable of enhancing a sales promotion effect by effectually distributing the commercial article information to the customer because of distributing the commercial article information before the validity of the accumulated points of the customer expires.

Further, the customer information storage unit may further be stored with electronic mail address data of the customer, the commercial article announcement generating unit may generate an e-mail-based announcement of the commercial article describing the contents of the commercial article data searched for by the recommended commercial article searching unit, and the commercial article announcement providing unit may provide the customer with the announcement of the commercial article by transmitting the e-mail-based announcement of the commercial article generated by the commercial article announcement generating unit to a destination specified by e-mail address data of the customer, which is stored in the customer information storage unit.

According to this configuration, the announcement of the commercial article is provided by the e-mail to the customer before the validity of the accumulated points expires, and it is therefore feasible to effectively provide the commercial article information to the customer.

Still further, the commercial article announcement generating unit may generate a Web-page-based announcement of the commercial article describing the contents of the commercial article data searched for by the recommended commercial article searching unit, and the commercial article announcement providing unit may provide the customer with the Web-page-based announcement of the commercial article generated by the commercial article announcement generating unit in a way that makes accessible via a network.

According to this configuration, the customer can be provided with the announcement of the commercial article each time the customer accesses the Web page generated by the commercial article announcement generating unit.

Yet further, the information processing device may further comprise a customer analyzing unit analyzing a purchase tendency of the customer by classifying the purchase tendency according to categories of individual information from an access log recoded when the customer accesses a Website, and adding an analyzed result to the commercial article data, wherein the customer information storage unit may be further stored with the data of the individual information of the customer, and the commercial article searching unit may search for the commercial article data coincident with the purchase tendency of the customer from the data of the individual information in the items of commercial article data matching with the price zone of the commercial article, which is searched for by the price zone acquiring unit.

According to this configuration, the customer can be provided with the announcement of the commercial article along the purchase tendency of the customer himself or herself.

Moreover, the customer information storage unit may be further stored with data about a point invalidation notifying date defined as a date when notifying the customer that the validity of the benefit points expires, and the price zone searching unit may search for the price zone data of the commercial article if the date data acquired by the date acquiring unit is coincident with the point invalidation notifying date data stored in the customer information storage unit.

Additionally, the present disclosure may also be an information processing method by which any one of the functions described above is carried out. Further, the present disclosure may also be an information processing program that makes a computer execute any one of the functions described above. Yet further, the present disclosure may also be a readable-by-computer recording medium recorded with the information processing program.

It is possible to provide the information processing device, the information processing method and the information processing program that are capable of enhancing the sales promotion effect by effectually distributing the announcement of the commercial article to the customers.

### BRIEF DESCRIPTION OF THE DRAWINGS

FIG. 1 is diagram of a whole configuration, showing a Web server, a communication network and a client;

FIG. 2 is a diagram showing contents of a customer information database;

FIG. 3 is a diagram showing contents of a commercial article information database;

FIG. 4 is a diagram showing contents of an extracting condition database;

FIG. 5 is a processing flowchart of a Web server;

FIG. 6 is a diagram showing contents of an announcement of the commercial article that is generated by a commercial article announcement generating unit;

FIG. 7 is a diagram of a whole configuration, showing the Web server, the communication network and the client according to a modified example;

FIG. 8 is a diagram showing the contents of the commercial article information database according to the modified example;

FIG. 9 is a diagram showing the contents of the customer information database according to the modified example, and

FIG. 10 is a processing flowchart of the Web server according to the modified example.

### DETAILED DESCRIPTION OF THE INVENTION

An information processing device, an information processing method and an information processing program according to a preferred embodiment of the present disclosure will hereinafter be described with reference to the drawings. The present embodiment is an exemplification, and the present disclosure is not limited to the exemplification.

<Configuration>

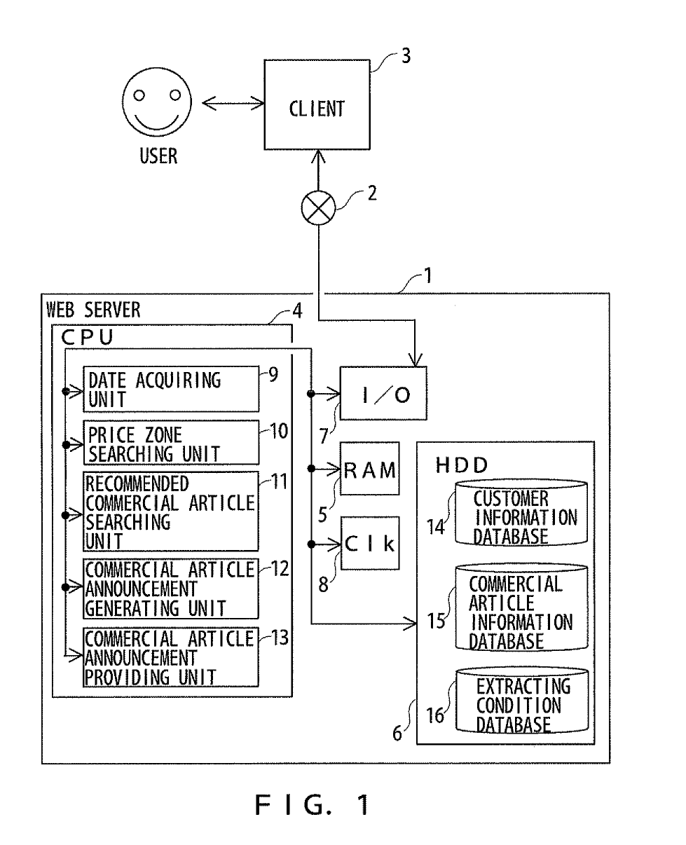

FIG. 1 is a diagram of a whole configuration, showing a Web server 1 in the embodiment, a communication network 2 connected to the Web server 1, and a client 3 connected to the communication network 2. As illustrated in FIG. 1, the Web server 1 has a communication-enabled configuration with the client 3 via the communication network 2. The Web server 1 is a server computer operated by an information provider who provides various categories of information services, and is installed in an office building etc of a company that operates the Web server 1. The communication network 2 is a computer network using TCP/IP (Transmission Control Protocol/Internet Protocol) protocol. The client 3 is a personal computer possessed by a customer, and is installed in a house etc of the customer. Note that the embodiment is based on such a premise that the client 3 is a personal computer, however, the present disclosure is not limited to the personal computer and may also be, for example, a mobile phone and a portable information terminal such as a PDA (personal Digital Assistant), which are capable of receiving electronic mails and accessing Websites. Further, an assumption in FIG. 1 is that though only one client 3 is illustrated, a multiplicity of clients 3 is connected to the communication network 2.

The Web server 1 is constructed of a CPU (Central Processing Unit) 4, a memory 5, a hard disk 6, an input/output interface 7, an internal clock 8, etc. The CPU 4 executes an information processing program stored in the hard disk 6 etc, and cooperates in function with the memory 5, the input/output interface 7 and the internal clock 8, thereby realizing various functions such as a date acquiring unit 9, a price zone searching unit 10, a recommended commercial article searching unit 11, a commercial article announcement generating unit 12 and a commercial article announcement providing unit 13.

The hard disk 6 defined as a recording medium controls roles of [a customer information storage unit], [a commercial article information storage unit] and [an extracting condition storage unit] according to the present disclosure. Namely, a customer information database 14, a commercial article information database 15 and an extracting condition database 16 are built up in an interior of the hard disk 6.

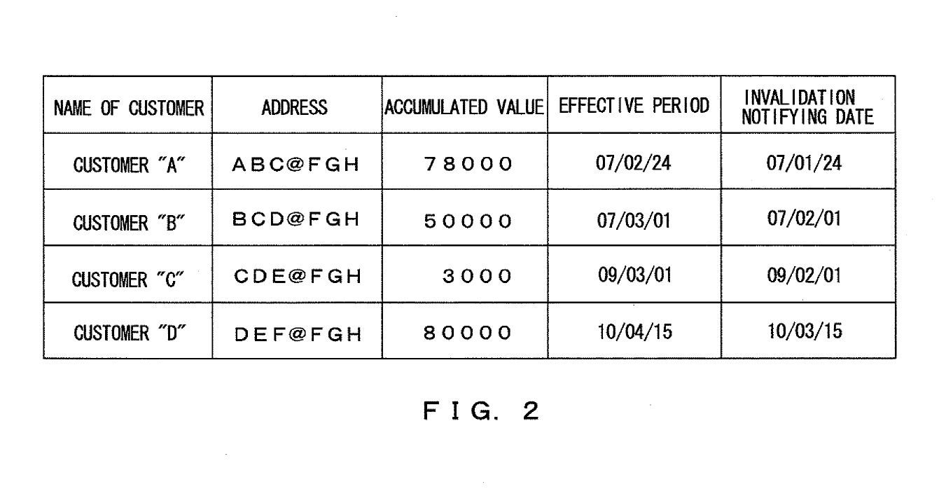

FIG. 2 shows contents of the customer information database 14. As shown in FIG. 2, the customer information database 14 is organized by records of data each consisting of fields such as an electronic mail (e-mail) address, an accumulated value of benefit points possessed by the customer, an effective period of the points, and a point invalidation notifying date representing a notifying date when the validity of the points will expire. As illustrated in FIG. 2, these items of information are sorted based on the individual customers and thus organized into the database.

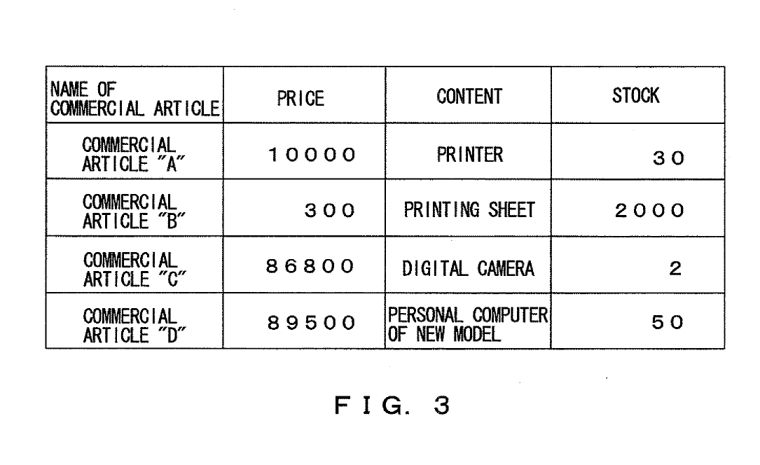

FIG. 3 shows contents of the commercial article information database 15. As illustrated in FIG. 3, the commercial article information database 15 is organized by records of data each consisting of fields such as a price of the commercial article, a content, and a stock.

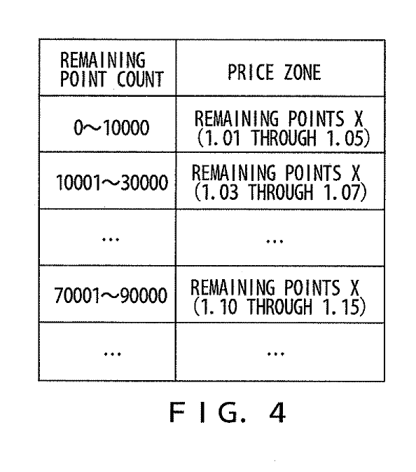

FIG. 4 shows contents of the extracting condition database 16. As illustrated in FIG. 4, the extracting condition database 16 is organized by records of data of extracting conditions each representing a relationship, determined corresponding to an accumulated point count (remaining point count), between a price zone of the commercial article introduced to the customer and the accumulated point count.

The date acquiring unit 9 acquires the present date and time from an integrated value of a counter based on an internal clock 8.

The price zone searching unit 10 has a function of searching the database for the data coincident with a desired search condition, and processes the items of data such as the present date acquired by the date acquiring unit 9, the point invalidation notifying data and the accumulated point count within the customer information database 14, and the price zone data etc within the extracting condition database 16. The price zone searching unit 10 provides the processed data to the recommended commercial article searching unit 11.

The recommended commercial article searching unit 11 has, in the same way as by the price zone searching unit 10, the function of searching the database for the data coincident with a desired search condition, and processes the items of data such as the data provided from the price zone searching unit 10, and the commercial article data and the price data within the commercial article information database 15. The recommended commercial article searching unit 11 provides the processed data to the commercial article announcement generating unit 12.

The commercial article announcement generating unit 12 has a function of editing the information provided to the customer, and generates an announcement of the commercial article in a way that includes the commercial article data searched for by the recommended commercial article searching unit 11. The commercial article announcement generating unit 12 provides the data of the thus-generated announcement of the commercial article to the commercial article announcement providing unit 13. Incidentally, a premise in the embodiment is that the commercial article announcement generating unit 12 generates the announcement of the commercial article in a format of the e-mail and distributes the announcement of the commercial article to the customers. The present disclosure is not, however, limited to this format, and the commercial article announcement generating unit 12 may generate the announcement of the commercial article in a format of the Web page. In this case, the system requests the customer to input a log-in ID, a password, etc in order to make the customer identifiable.

The commercial article announcement providing unit 13 has a communication-enabled configuration with the client 3 via the input/output interface 7 and the communication network 2, and provides the data of the announcement of the commercial article, which is generated by the commercial article announcement generating unit 12, to the client 3, thereby providing the contents of the announcement of the commercial article to the customer. In the embodiment, the commercial article announcement generating unit 12 generates the announcement of the commercial article in the e-mail format, and hence the commercial article announcement providing unit 13 distributes the e-mail of the announcement of the commercial article to the client 3. The present disclosure is not, however, limited to this scheme, and, if the commercial article announcement generating unit 12 generates the announcement of the commercial article in the Web-page format, the commercial article announcement providing unit 13 enables the Web-page generated by the commercial article announcement generating unit 12 to be accessed via the communication network 2, thereby providing the contents of the announcement of the commercial article to the customer.

<Processing Flow>

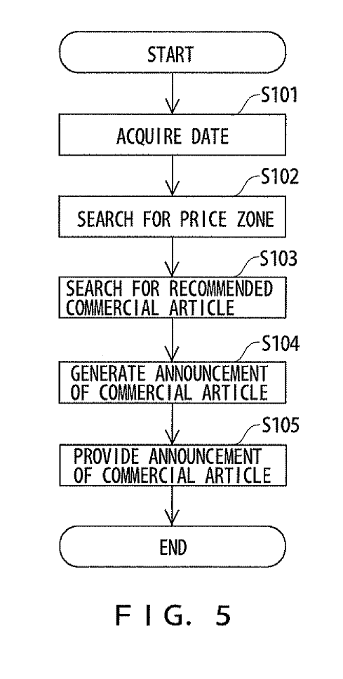

Next, a processing flow of the Web server 1 according to one embodiment of the present disclosure will be explained. FIG. 5 is a processing flowchart of the Web server 1. The information processing flow of the Web server 1 will hereinafter be described with reference to the flowchart in FIG. 5.

When the Web server 1 is started up, the date acquiring unit 9 acquires the present date and time from the integrated value of the counter based on the internal clocks (step S101).

An assumption in the embodiment is that the date acquiring unit 9 acquires the data of the date, e.g., [Jan. 24, 2007].

Next, the price zone searching unit 10 searches the customer information database 14 for the point invalidation notifying date data coincident with the data of the present date acquired by the date acquiring unit 9. Then, the price zone searching unit 10 searches the extracting condition database 16 for the price zone data associated with the accumulated point count possessed by the customer showing the coincidence of the present date data with the point invalidation notifying date data (step S102).

In the embodiment, the date acquiring unit 9 acquires the data of the date [Jan. 24, 2007], and therefore the price zone searching unit 10 searches the customer information database 14 in FIG. 2 for the customer data specified by a [customer A] Then, the accumulated point count of the customer A is [78000], and hence the price zone searching unit 10 retrieves, from the extracting condition database 16, the price zone data give by [the remaining points×(1.10 through 1.15), i.e., the price zone data of [85800 through 89700] given by 78000×1.10=85800 and 78000×1.15=89700.

Next, the recommended commercial article searching unit 11 searches the commercial article information database 15 for the commercial article data having the price matching with the price zone data retrieved by the price zone searching unit 10 (step S103).

In the embodiment, the price zone searching unit 10 retrieves the price zone data such as [85800 through 89700 and hence the recommended commercial article searching unit 11 searches the commercial article information database 15 in FIG. 3 for the commercial article data of the commercial articles such as a [commercial article C] and a [commercial article D].

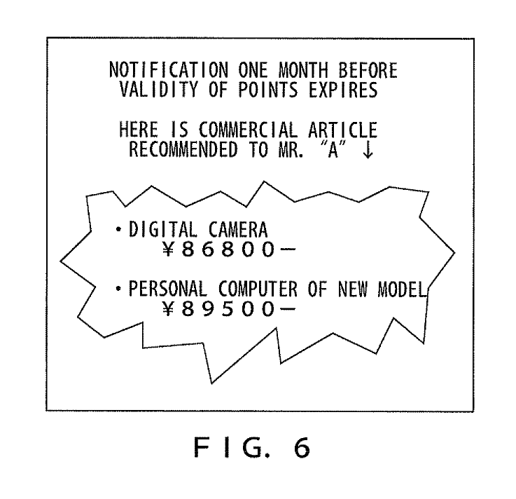

Next, the commercial article announcement generating unit 12 generates the e-mail announcement of the commercial article based on the commercial article data searched for by the recommended commercial article searching unit 11 (step S104). FIG. 6 illustrates the contents of the announcement of the commercial article, which is generated by the commercial article announcement generating unit 12. As illustrated in FIG. 6, the commercial article announcement generating unit 12 generates the e-mail for the announcement of the commercial article, which is organized by the contents (namely, for example, the price and the content of the commercial article, existence or non-existence of the stock, a deficient amount of money obtained by subtracting the accumulated point count from the price of the commercial article, and so on) of the commercial article data searched for by the recommended commercial article searching unit 11.

Subsequently, the commercial article announcement providing unit 13 transmits, to the client 3, the e-mail for the announcement of the commercial article, which is generated by the commercial article announcement generating unit 12 (step S105).

<Effects>

The Web server 1 according to the embodiment distributes, before the validity of the benefit points possessed by the customer expires, the announcement of the commercial article corresponding to the accumulated point count and therefore can distribute effectually the announcement of the commercial article to the customer.

<Configuration of Modified Example>

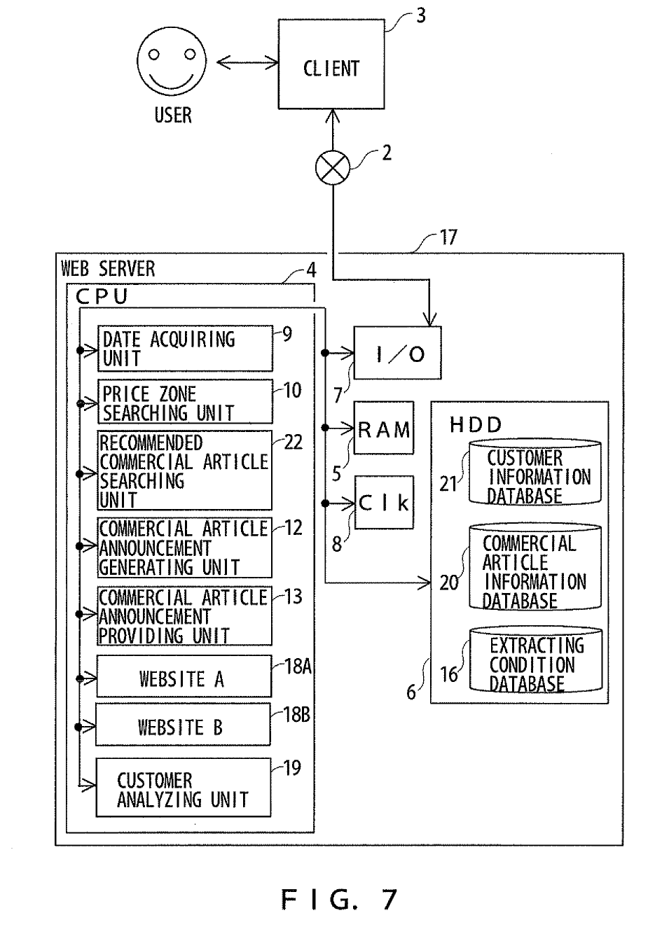

A modified example of the Web server 1 will hereinafter be described. FIG. 7 shows a diagram of a whole configuration of a Web server 17 as a modified example of the Web server 1, the communication network 2 and the client 3. As illustrated in FIG. 7, a multiplicity of Websites 18A, 18B is built up within the Web server 17. Further, the Web server 17 further includes a customer analyzing unit 19. Note that the components having the same functions and same operations as those of the components of the Web server 1 are marked with the same numerals, and their detailed explanations are omitted.

The customer analyzing unit 19 classifies a purchase tendency of the customer according to categories of the individual information (e.g., an age, a distinction of sex, an address, an accumulated point count of the benefit points, etc) and analyzes the purchase tendency from access logs of the Websites 18A, 18B. The customer analyzing unit 19, after analyzing the purchase tendency of the customer, accesses the hard disk 6 and adds the data of the analyzed result about the customer's purchase tendency according to the distinction of sex, the age, the usage of the points count, etc to the data of the commercial article in a commercial article information database 20. Thus, the information on the distinction of sex and the age of the customer who purchased the commercial article is accumulated in the commercial article information database 20, thereby enabling a grasp of the tendency of a group of the purchasers of the commercial article.

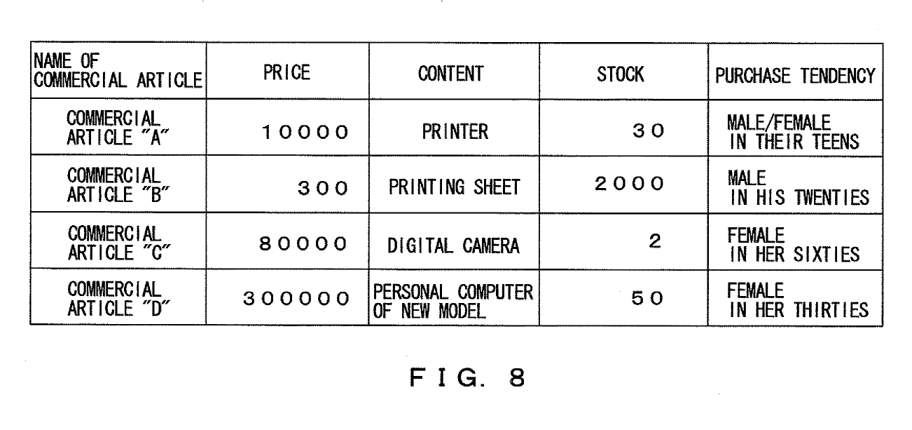

FIG. 8 shows contents of the commercial article information database 20 to which the data of the analyzed result about the customer's purchase tendency is added. As shown in FIG. 8, the commercial article information database 20 is accumulated with the items of information, according to every commercial article, such as an age group, the distinction of sex, the age and the hold points of the purchaser who purchased the commercial article.

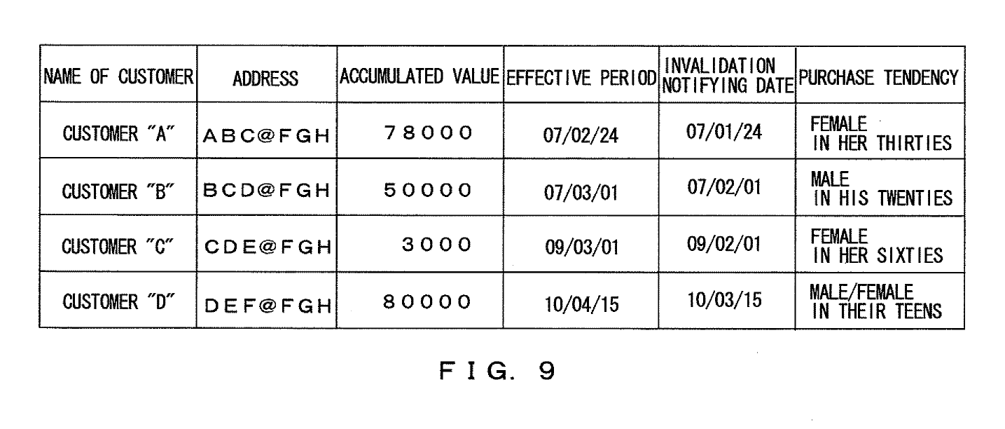

FIG. 9 shows contents of a customer information database 21. As illustrated in FIG. 9, in addition to the data such as the e-mail address, the accumulated value of the benefit points, the effective period of the points and the point invalidation notifying date, the data of the individual information such as the age, the age group and the distinction of sex of the customer is added to the customer information database 21.

A recommended commercial article searching unit 22 has a function of searching the database for the data coincident with a desired search condition, then acquires the data provided by the price zone searching unit 10, the commercial article data, the price data and the data of the analyzed result about the customer's purchase tendency in the commercial article information database 20 and the data of the individual information in the customer information database 21, and processes these items of data.

<Processing Flow of Modified Example>

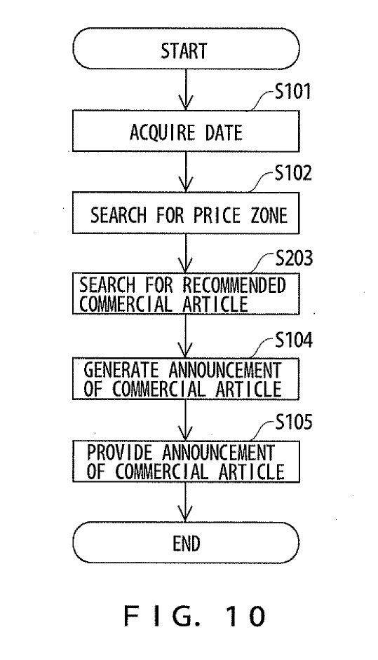

Next, a processing flow of the Web server 17 according to a modified example will be explained. FIG. 10 is a processing flowchart of the Web server 17. An information processing flow of the Web server 17 will hereinafter be described with reference to the flowchart in FIG. 10. Note that for the explanatory convenience, the same processes as by the Web server 1 are marked with the same symbols, and their explanations are omitted.

When finishing step S101 and step S102, the recommended commercial article searching unit 22 searches the commercial information database 20 for the commercial article data showing the coincidence of the data of the individual information in the customer information database 21 with the data of the analyzed result about the customer's purchase tendency in the commercial information database 20 in the items of the commercial article data of the price zone matching with the price zone data of the commercial article, which is retrieved by the price zone searching unit 10 (step S203).

The modified example is that in the commercial article data (i.e., the commercial article data of a [commercial article C] and a [commercial article D]) of the price zone matching with the price zone data of the commercial article, which is retrieved by the price zone searching unit 10, the [commercial article D] shows the coincidence of the data of the individual information (i.e., a [female in her thirties]) of the customer A in the customer information database 21 with the data of the analyzed result about the purchase tendency in the commercial information database 20. Hence, the recommended commercial article searching unit 22 searches for the commercial article data of the [commercial article D].

Then, upon finishing step S104 and step S105, a series of information processes are completed.

<Effects of Modified Example>

According to the modified example, since the announcement of the commercial article, which is distributed to the customer, is the information reflected in the customer's purchase tendency, the customer can be provided with the announcement of the commercial article along the purchase tendency of the customer himself or herself, and further it is feasible to reduce a load on the information processing system by restraining a futile increase in traffic.

<Readable by Computer Recording Medium>

A program for making a computer, other machines and devices (which will hereinafter be referred to as the computer etc) realize any one of the functions can be recorded on a recording medium readable by the computer etc. Then, the computer etc is made to read and execute the program on this recording medium, whereby the function thereof can be provided.

Herein, the recording medium readable by the computer etc connotes a recording medium capable of storing information such as data and programs electrically, magnetically, optically, mechanically or by chemical action, which can be read from the computer etc. Among these recording mediums, for example, a flexible disc, a magneto-optic disc, a CD-ROM, a CD-R/W, a DVD, a DAT, an 8 mm tape, a memory card, etc are given as those removable from the computer.

Further, a hard disc, a ROM (Read-Only Memory), etc are given as the recording mediums fixed within the computer etc.

What is claimed is:

1. An information processing device comprising:
a customer information storage unit stored with point count data defined as benefit points given to a customer;
a commercial article information storage unit stored with commercial article data showing contents of a commercial article and with price data showing a price of the commercial article;
an extracting condition storage unit stored with extracting condition data showing an associated relationship between the point count data and price zone data of the commercial article introduced to the customer;
a date acquiring unit acquiring date data defined as a present date;
a price zone searching unit searching for, when the date data acquired by the date acquiring unit and an invalidation date of the benefit points specified by the point count data stored in the customer information storage unit come to a predetermined relationship, the price zone data of the commercial article, which is associated with the point count data stored in the customer information storage unit by use of the extracting condition data stored in the extracting condition storage unit;
a recommended commercial article searching unit searching for the commercial article data matching with a price zone of the commercial article, which is searched for by the price zone acquiring unit, in a way that searches for the price data stored in the commercial article information storage unit;
a commercial article announcement generating unit generating an announcement of the commercial article, which describes the contents of the commercial article data searched for by the recommended commercial article searching unit; and
a commercial article announcement providing unit providing the announcement of the commercial article, which is generated by the commercial article announcement generating unit, to the customer.

2. The information processing device according to claim 1, wherein the customer information storage unit is further stored with electronic mail address data of the customer,
the commercial article announcement generating unit generates an e-mail-based announcement of the commercial article describing the contents of the commercial article data searched for by the recommended commercial article searching unit, and
the commercial article announcement providing unit provides the customer with the announcement of the commercial article by transmitting the e-mail-based announcement of the commercial article generated by the commercial article announcement generating unit to a destination specified by e-mail address data of the customer, which is stored in the customer information storage unit.

3. The information processing device according to claim 1, wherein the commercial article announcement generating unit generates a Web-page-based announcement of the commercial article describing the contents of the commercial article data searched for by the recommended commercial article searching unit, and
the commercial article announcement providing unit provides the customer with the Web-page-based announcement of the commercial article generated by the commercial article announcement generating unit in a way that makes accessible via a network.

4. The information processing device according to claim 1, further comprising a customer analyzing unit analyzing a purchase tendency of the customer by classifying the purchase tendency according to categories of individual information from an access log recoded when the customer accesses a Website, and adding an analyzed result to the commercial article data,
wherein the customer information storage unit is further stored with the data of the individual information of the customer, and
the commercial article searching unit searches for the commercial article data coincident with the purchase tendency of the customer from the data of the individual information in the items of commercial article data matching with the price zone of the commercial article, which is searched for by the price zone acquiring unit.

5. The information processing device according to claim 1, wherein the customer information storage unit is further stored with data about a point invalidation notifying date defined as a date when notifying the customer that the validity of the benefit points expires, and
the price zone searching unit searches for the price zone data of the commercial article if the date data acquired by the date acquiring unit is coincident with the point invalidation notifying date data stored in the customer information storage unit.

6. An information processing method executed by an information processing device comprising:
a customer information storage unit stored with point count data defined as benefit points given to a customer;
a commercial article information storage unit stored with commercial article data showing contents of a commercial article and with price data showing a price of the commercial article; and
an extracting condition storage unit stored with extracting condition data showing an associated relationship between the point count data and price zone data of the commercial article introduced to the customer, the method comprising:
a date acquiring step of acquiring date data defined as a present date;
a price zone searching step of searching for, when the date data acquired in the date acquiring step and an invalidation date of the benefit points specified by the point count data stored in the customer information storage unit come to a predetermined relationship, the price zone data of the commercial article, which is associated with the point count data stored in the customer information storage unit by use of the extracting condition data stored in the extracting condition storage unit;
a recommended commercial article searching step of searching for the commercial article data matching with a price zone of the commercial article, which is searched for in the price zone acquiring step, in a way that searches for the price data stored in the commercial article information storage unit;
a commercial article announcement generating step of generating an announcement of the commercial article, which describes the contents of the commercial article data searched for in the recommended commercial article searching step; and
a commercial article announcement providing step of providing the announcement of the commercial article, which is generated in the commercial article announcement generating step, to the customer.

7. The information processing method according to claim 6, wherein the customer information storage unit is further stored with electronic mail address data of the customer,
the commercial article announcement generating step includes generating an e-mail-based announcement of the commercial article describing the contents of the commercial article data searched for in the recommended commercial article searching step, and
the commercial article announcement providing step includes providing the customer with the announcement of the commercial article by transmitting the e-mail-based announcement of the commercial article generated in the commercial article announcement generating step to a destination specified by e-mail address data of the customer, which is stored in the customer information storage unit.

8. The information processing method according to claim 6, wherein the commercial article announcement generating step includes generating a Web-page-based announcement of the commercial article describing the contents of the commercial article data searched for in the recommended commercial article searching step, and
the commercial article announcement providing step includes providing the customer with the Web-page-based announcement of the commercial article generated in the commercial article announcement generating step in a way that makes accessible via a network.

9. The information processing method according to claim 6, further comprising a customer analyzing step of analyzing a purchase tendency of the customer by classifying the purchase tendency according to categories of individual information from an access log recoded when the customer accesses a Website, and adding an analyzed result to the commercial article data,
wherein the customer information storage unit is further stored with the data of the individual information of the customer, and
the commercial article searching step includes searching for the commercial article data coincident with the purchase tendency of the customer from the data of the individual information in the items of commercial article data matching with the price zone of the commercial article, which is searched for in the price zone acquiring step.

10. The information processing method according to claim 6, wherein the customer information storage unit is further stored with data about a point invalidation notifying date defined as a date when notifying the customer that the validity of the benefit points expires, and
the price zone searching step includes searching for the price zone data of the commercial article if the date data acquired in the date acquiring step is coincident with the point invalidation notifying date data stored in the customer information storage unit.

11. A recoding medium recorded an information processing program executed by an information processing device comprising:
a customer information storage unit stored with point count data defined as benefit points given to a customer;
a commercial article information storage unit stored with commercial article data showing contents of a commercial article and with price data showing a price of the commercial article; and
an extracting condition storage unit stored with extracting condition data showing an associated relationship between the point count data and price zone data of the commercial article introduced to the customer, the program making the information processing device execute:
a date acquiring step of acquiring date data defined as a present date;
a price zone searching step of searching for, when the date data acquired in the date acquiring step and an invalidation date of the benefit points specified by the point count data stored in the customer information storage unit come to a predetermined relationship, the price zone data of the commercial article, which is associated with the point count data stored in the customer information storage unit by use of the extracting condition data stored in the extracting condition storage unit;
a recommended commercial article searching step of searching for the commercial article data matching with a price zone of the commercial article, which is searched for in the price zone acquiring step, in a way that searches for the price data stored in the commercial article information storage unit;
a commercial article announcement generating step of generating an announcement of the commercial article, which describes the contents of the commercial article data searched for in the recommended commercial article searching step; and
a commercial article announcement providing step of providing the announcement of the commercial article, which is generated in the commercial article announcement generating step, to the customer.

12. The recoding medium recorded the information processing program according to claim 11, wherein the customer information storage unit is further stored with electronic mail address data of the customer,
the commercial article announcement generating step includes generating an e-mail-based announcement of the commercial article describing the contents of the commercial article data searched for in the recommended commercial article searching step, and
the commercial article announcement providing step includes providing the customer with the announcement of the commercial article by transmitting the e-mail-based announcement of the commercial article generated in the commercial article announcement generating step to a destination specified by e-mail address data of the customer, which is stored in the customer information storage unit.

13. The recoding medium recorded the information processing program according to claim 11 wherein the commercial article announcement generating step includes generating a Web-page-based announcement of the commercial article describing the contents of the commercial article data searched for in the recommended commercial article searching step, and
the commercial article announcement providing step includes providing the customer with the Web-page-based announcement of the commercial article generated in the commercial article announcement generating step in a way that makes accessible via a network.

14. The recoding medium recorded the information processing program according to claim 11, further comprising a customer analyzing step of analyzing a purchase tendency of the customer by classifying the purchase tendency according to categories of individual information from an access log recoded when the customer accesses a Website, and adding an analyzed result to the commercial article data,
wherein the customer information storage unit is further stored with the data of the individual information of the customer, and
the commercial article searching step includes searching for the commercial article data coincident with the purchase tendency of the customer from the data of the individual information in the items of commercial article data matching with the price zone of the commercial article, which is searched for in the price zone acquiring step.

15. The recoding medium recorded the information processing program according to claim 11, wherein the customer information storage unit is further stored with data about a point invalidation notifying date defined as a date when notifying the customer that the validity of the benefit points expires, and
the price zone searching step includes searching for the price zone data of the commercial article if the date data acquired in the date acquiring step is coincident with the point invalidation notifying date data stored in the customer information storage unit.
